(19) United States
(12) Patent Application Publication
(10) Pub. No.: US 2009/0235184 A1
(43) Pub. Date: Sep. 17, 2009

(54) SYSTEMS AND METHODS FOR INSTANT MESSAGING

(76) Inventors: Wendy Charlene Perlson, San Mateo, CA (US); Ethan Alvah Fassett, San Francisco, CA (US)

Correspondence Address: XIN WEN, 3449 RAMBOW DRIVE, PALO ALTO, CA, 94306, US

(21) Appl. No.: 12/049,105

(22) Filed: Mar. 14, 2008

(51) Int. Cl. G06F 3/048

(52) U.S. Cl. 715/758

(57) ABSTRACT

An integrated IM user interface for exchanging instant messages (IM) in a network-based community includes a text entry area configured to receive a text message from a first user and a first graphic representation representing a second user. The first graphic representation can be activated by the first user to start an IM session between the first user and the second user. A second graphic representation represents a third user associated with the first user. The second graphic representation can be activated by the first user to start an IM session between the first user and the third user. A chat window displays text messages between the first user and the second user or between the first user and the third user.

### TECHNICAL FIELD

This application relates to user interface, systems, and methods for instant messaging.

### BACKGROUND

An Instant Messenger (IM) program allows a user to send instant messages to other users on a network such as the Internet. IM enables a user to create a private chat room to communicate with another individual in real time over the Internet. IM is analogous to a telephone conversation, but uses text-based, not voice-based, communication. Typically, an IM system alerts a user whenever somebody on the user's private list is online. The user may then initiate a chat session with that particular individual.

A user may perform any number of functions with an IM program, which can include viewing the user's contacts who are online, sending an instant message, calling a contact's computer, sending a contact a file, having an instant message conversation with a group of friends, inviting someone to play a game, being notified of new e-mail messages from an e-mail account, and other activities.

A challenge associated with the current instant messaging program is to provide a user-friendly system to allow a user to easily understand and manage multiple IM sessions concurrently running on the user's computer device.

### SUMMARY

In one aspect, the present invention relates to an integrated IM user interface for exchanging instant messages (IM) in a network-based community. The integrated IM user interface includes a text entry area configured to receive a text message from a first user, a first graphic representation representing a second user, wherein the first graphic representation can be activated by the first user to start an IM session between the first user and the second user, a second graphic representation representing a third user associated with the first user, wherein the second graphic representation can be activated by the first user to start an IM session between the first user and the third user, and a chat window that can display text messages between the first user and the second user or between the first user and the third user.

In another aspect, the present invention relates to an integrated IM user interface for exchanging instant messages (IM) in a network-based community. The integrated IM user interface includes a text entry area that can receive a text message from a first user; a first graphic representation representing a second user, wherein the first graphic representation can be activated by the first user to start an IM session between the first user and the second user; a plurality of graphic representations each representing a different user associated with the first user, the first graphic representation and the plurality of graphic representations are positioned adjacent to each other, wherein each of graphic representations can be activated by the first user to start an IM session between the first user and the user represented by the graphic representation; a first symbol in association with one of the plurality of graphic representations, wherein the first symbol indicates one or more new or an unread instant message(s) sent by a different user represented by the one of the plurality of graphic representations; a chat window configured to display text messages between the first user and the second user or between the first user and one of the different users represented by the plurality of graphic representations; a control button which when actuated, allows the first user to send a text message to the second user or one of the different users; an icon positioned adjacent to the first graphic representation or the plurality of graphic representations. The icon is configured to indicate new or an unread forum posting(s) from users associated with the first user, and wherein the icon can be activated by the first user to view forum posting(s) from the users associated with the first user.

In yet another aspect, the present invention relates to a network-based instant messages (IM) system that includes one or more servers configured to provide an integrated IM user interface on a first remote computer device. The integrated IM user interface comprises: a text entry area that can receive a text message from a first user; a first graphic representation representing a second user operating a second remote computer device, wherein the first graphic representation can be activated by the first user to start an IM session between the first user and the second user; a second graphic representation representing a third user operating a third remote computer device, wherein the second graphic representation can be activated by the first user to start an IM session between the first user and the third user; and a chat window configured to display text messages between the first user and the second user or between the first user and the third user. The one or more servers can transmit the text messages between the first remote computer device and the second remote computer device, or between the first remote computer device and the third remote computer device. A computer storage device can store the text messages, the first graphic representation, and the second graphic representation.

Implementations of the system may include one or more of the following. The first graphic representation can be an avatar that is designed or selected by the second user. The first graphic representation can be positioned adjacent to the second graphic representation in a same functional area of the integrated IM user interface. The integrated IM user interface can further include a symbol in association with the second graphic representation. The symbol can indicate new or an unread instant message(s) sent by the third user. The integrated IM user interface can further include a plurality of graphic representations each representing a different user associated with the first user. Each of graphic representations can be activated by the first user to start an IM session between the first user and the user represented by the graphic representation. There can be six or more graphic representations each representing a different user associated with the first user. The integrated IM user interface can further include an icon configured to indicate forum posting(s) from users associated with the first user. The icon can be activated by the first user to view forum posting(s) from the users associated with the first user. The icon can be positioned adjacent to the first graphic representation in a same functional area of the integrated IM user interface. The integrated IM user interface can further include a symbol in association of the icon. The symbol is configured to indicate new or an unread forum posting(s) from users associated with the first user. The integrated IM user interface can further include a functional area configured to display an IM user name for the first user or for the second user. The integrated IM user interface can further include a functional area configured to display status information about the second user. The status information comprises a subscription of the second user to on or more of a forum, an online community, or an online gaming service. The integrated IM user interface can further include a control button configured to allow the first user to send the text message by activating the control. The integrated IM user interface can further include a control button configured to facilitate the selection of a feature of the text message by activating the control wherein the feature is selected from a group consisting of font size, font color, and font style.

Embodiments may include one or more of the following advantages. The disclosed system and methods provide a user-friendly user interface for a user to communicate in multiple IM sessions on a single computer device. The disclosed system and methods allow multiple modes of communication within an integrated user interface, which can replace multiple applications and windows in a conventional computer system. The disclosed system and methods are much simpler than some IM conventional systems. IM sessions in the present invention can visualized in graphic designs and avatars that mimic the real world.

Details of one or more embodiments are set forth in the accompanying drawing and in the description below. Other features, objects, and advantages of the invention will become apparent from the description and drawings, and from the claims.

### BRIEF DESCRIPTION OF THE DRAWINGS

FIG. 1 is an exemplified system diagram of an instant messaging system.

FIGS. 2A-2C illustrate exemplified integrated IM user interfaces when an IM user is communicating with a buddy using IM service provided by an instant messaging system.

FIG. 3 illustrates another exemplified integrated IM user interface that can alert the IM user about new postings from one or more forums.

FIG. 4 illustrates a user interface showing postings from multiple forums subscribed by the IM user.

FIG. 5 is an exemplified flow diagram for instant messaging over a computer network.

### DETAILED DESCRIPTION

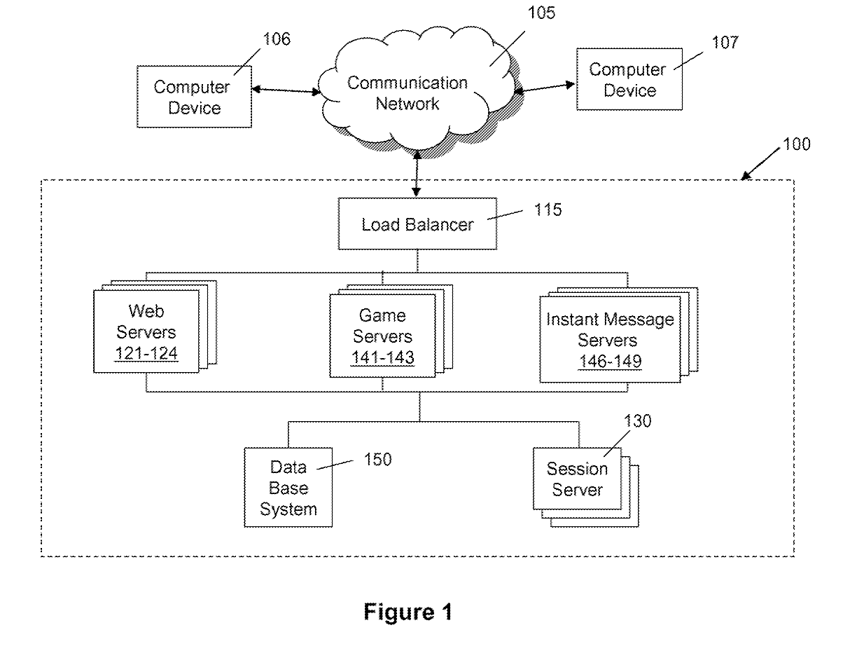

Referring to FIG. 1, an instant messaging system 100 includes a load balancer 115, one or more web servers 121-124, one or more session servers 130, a plurality of game servers 141-143, and a data base system 150. The data base system 150 can, for example, be implemented as a storage area network. The data base system 150 can store instant messages and forum postings as described below. The load balancer 115 can include one or a system of servers that are designed to ensure redundancy and reliability for the instant messaging system 100. The instant messaging system 100 also includes one or more instant message servers 146-149 for providing instant messaging services to web user interface on remote computer devices 106 and 107 via a computer network 105 such as the Internet. The instant message servers 146-149 or the web servers 121-124 can also provide a forum service where users of the computer devices 106 and 107 can be posted. In some embodiments, the instant messaging services can also be performed by the web servers 121-124 or the game servers 141-143. The instant messaging system 100 can be operated by a game service provider, such as Gaia Online, or other types of service providers. The instant messaging system 100 allows users of computer devices 106 and 107 to conduct instant messaging through a web browser such as Internet Explorer™ from Microsoft, Netscape™ from AOL, and Firebox™ from Mozilla, or a customized client application. The instant messaging system 100 can provide a website on the Internet to host a game community and provide various game services such as games, discussion groups, forums, and e-mails etc. Users can participate in the online interactive games using game applications running on computer devices 106 and 107 through a communication network 105.

The communication network 105 can include various wired, wireless, satellite communication arrangements including but not limited to a wide area network such as the Internet, a local area network, a cellular phone network under various communication protocols such as 2G, 2.5G and 3G, Global System for Mobile Communications (GSM), General Packet Radio Service (GPRS), EDGE, Code Division Multiple Access (CDMA), Wideband CDMA, TD-SCDMA, Universal Mobile Telecommunications System (UMTS), etc., city wide wires network such as WiMax, and wireless local area network (WLAN) such as Wi-Fi wireless communication standards such as IEEE 802.11, Wi-Max, and IEEE 806.16, and others. The computer devices 106 and 107 can include personal computers, portable digital assistance (PDA) devices, cell phones, digital image capture devices, and dedicated game devices such as Microsoft XBOX, SONY PlayStation OR PS2, Nintendo gaming machines, GameCube, or GameBoy.

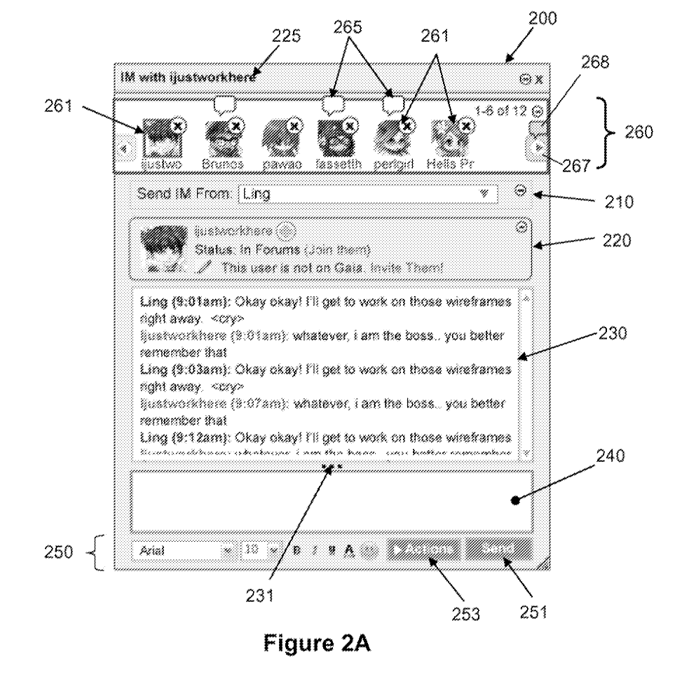

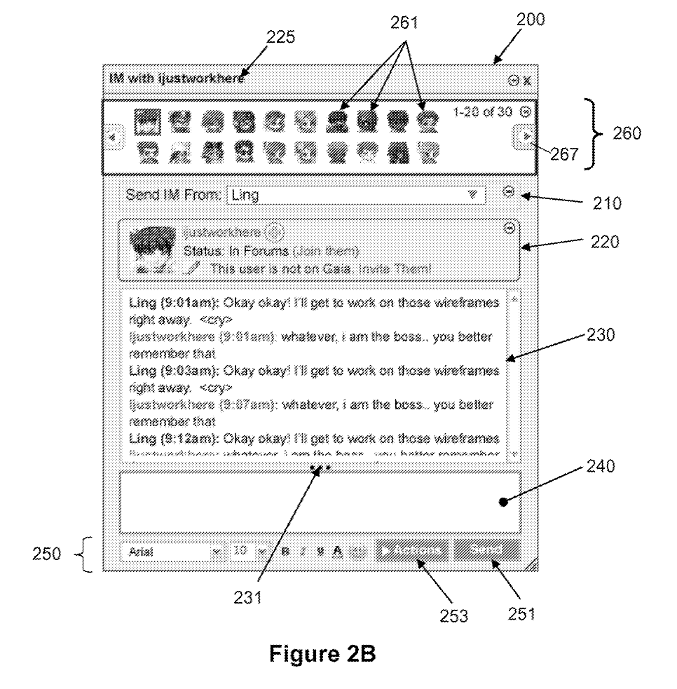

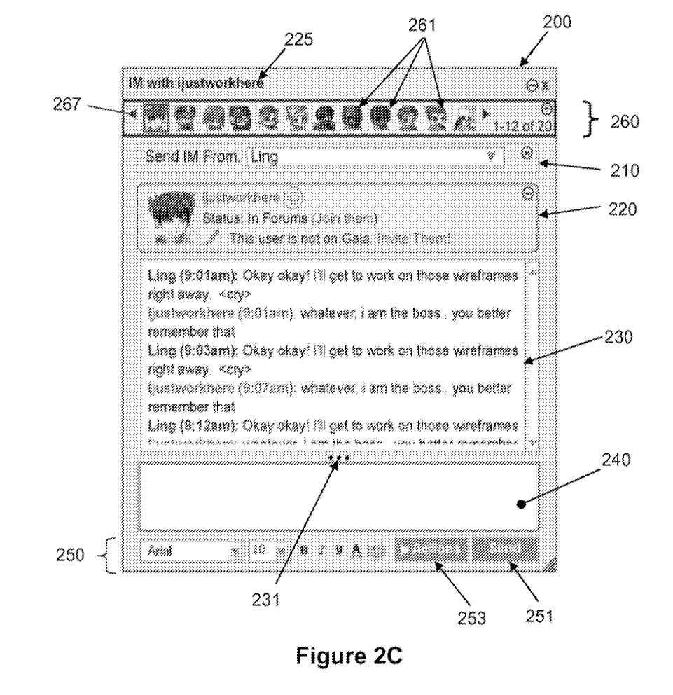

Referring to FIG. 2A, an integrated IM user interface 200 can be activated on the computer device 106 by an IM user “Ling” to communicate via the communication network 105 with another IM user “ijustworkhere” operating the computer device 107. The integrated IM user interlace 200 can be presented in a desktop environment as a part of a web browser. In an implementation, the integrated IM user interface 200 can be installed on the computer device 106 by downloading a software application from the instant messaging system 100. The integrated IM user interface 200 can be implemented as a plug-in to a web browser.

The integrated IM user interface 200 includes a functional area 210 that specifies the current user for the integrated IM user interface 200. The current user of the integrated IM user interface 200 can have more one IM user name. For example, the current user can select an IM user name “Ling” or other user names by using a pull down menu. An IM user can sign up to have one or more IM user names. The remote IM user “ijustworkhere” that “Ling” is currently communicating with is displayed in a header 225. A functional area 220 displays status information for the remote IM user. For example, the IM user “ijustworkhere” may be a member of online-gaming service such as Gaia Online and a member of a forum provided by Gaia Online. The IM user “Ling” of the integrated IM user interface 200 can click at a button “Join Them” to join the forum that the remote IM user “ijustworkhere” is in. The current user “Ling” of the integrated IM user interface 200 can also click at a button “Invite them!” to invite the remote IM user “ijustworkhere” to join the game service such as Gaia Online or to join a forum where “Ling” is a member of. The functional area 220 thus allows the user of the integrated IM user interface 200 to effectively identify the status information of the remote IM user and to connect with the remote IM user in ways other than the IM messaging service.

A chat window 230 displays messages communicated between the user of the integrated IM user interlace 200 (e.g. “Ling”) and the remote IM user (e.g. “ijustworkhere”). The chat window 230 can display the IM user name of the sender and the time for each instant message. The incoming text messages from the remote IM user can be displayed instantly. The chat window 230 can be resized by grabbing and moving a button 231. A text entry area 240 can receive text messages from the user of the integrated IM user interface 200 to be sent to the remote IM user. The user of the integrated IM user interface 200 can send a text message displayed in the text entry area 240 by clicking a “send” button 251 to the remote IM user (e.g. “ijustworkhere”). A functional area 250 includes the “send” button 251, font type and font size selections, font style selections such as bold face, italic, underline, and colors, and a button 253 for additional actions such as “Roll Dice” (that generates random number, as if a die were thrown), “Random Number”, “Display Inventory” (that displays virtual item inventory of the IM user at a gaming site such as Gaia Online), and “Display Friends” (that displays the IM user's friends at an online gaming site such as Gaia Online).

The integrated IM user interface 200 further includes a functional area 260 to indicate friends of “Ling” that are having “live” conversations using the IM service by the instant messaging system 100 via the communication network 105. The functional area 260 includes a carousal of avatars 261 that represent Ling's friends with IM user names such as “ijustworkhere”, “Brunos”, “Pawao”, “Fassetth”, “Perigirl”, and “Hells Pr”. The avatars 261 are designed or selected by their respective owners, and can mimic the gender, the appearance and personaly of each of the IM users. The friends of “Ling” can be derived, for example, from a buddies' list that “Ling” has from her account at gaming service such as Gaia Online, or from an address book of an email service. The IM user “Ling” can click a button 267 to see more her friends that are having conversations in IM messaging as shown in FIGS. 2B and 2C. A blinking talk bubble 268 next to the button 267 can indicate to “Ling” that there are other users not currently displayed in the functional area 260 and have un-read messages that “Ling” might be interested in reading. The IM user (e.g. “Ling”) can scroll the button 267 to see these messages. As shown in FIGS. 2B and 2C, a large number of avatars representing different IM users can be simultaneously displayed in a single view in the functional area 260.

Referring back to FIG. 2A, the functional area 260 can also display talk bubbles 265 next to the avatars 261 that have sent new messages but have not been read by the IM user “Ling”. The user of the integrated IM user interface 200 can click on a “-” button on the upper right corners of the functional areas 210, 220 and 260 to minimize these areas. For example, when the IM user “Ling” wants to communicate only with the IM user “ijustworkhere”, “Ling” can minimize the functional areas 210, 220 and 260 to simplify the integrated IM user interface 200 while keeping only the basic IM communication functions. The integrated IM user interface can be closed by clicking an “x” button (at the upper right).

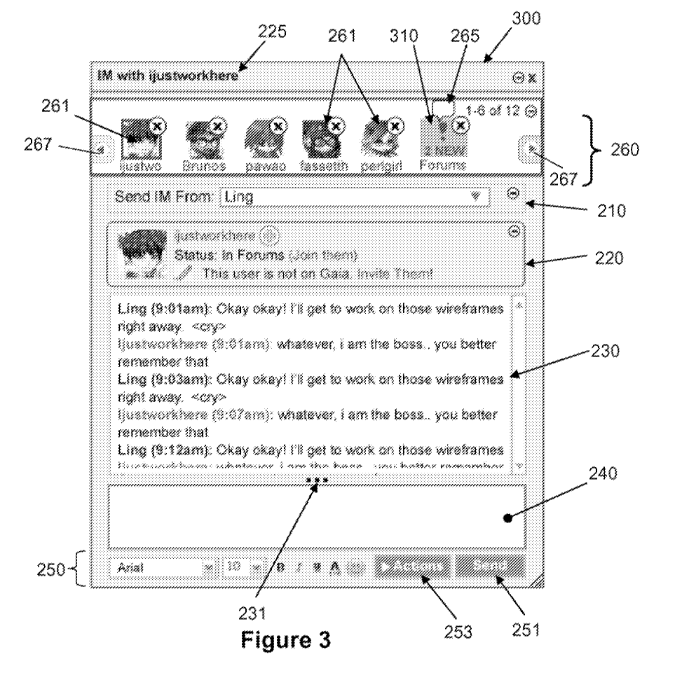

An advantage of the integrated IM user interface is that the graphic representations of the IM users (e.g. the avatars in the functional area 260) are intuitive to understand and easy to use. An IM user can easily monitor, manage, and conduct communications with a plurality of IM users. For example, the IM user “Ling” can click on each of the avatars 261 to start an IM session with the corresponding IM user. For example, referring to FIG. 3, “Ling” can click on the avatar 261 for IM user “Brunos” to read Brunos' new instant messages as indicated by the talk bubble next to his avatar. “Ling” can start an IM session with him. Text messages between “Ling” and “Brunos” appear in the chat window 230.

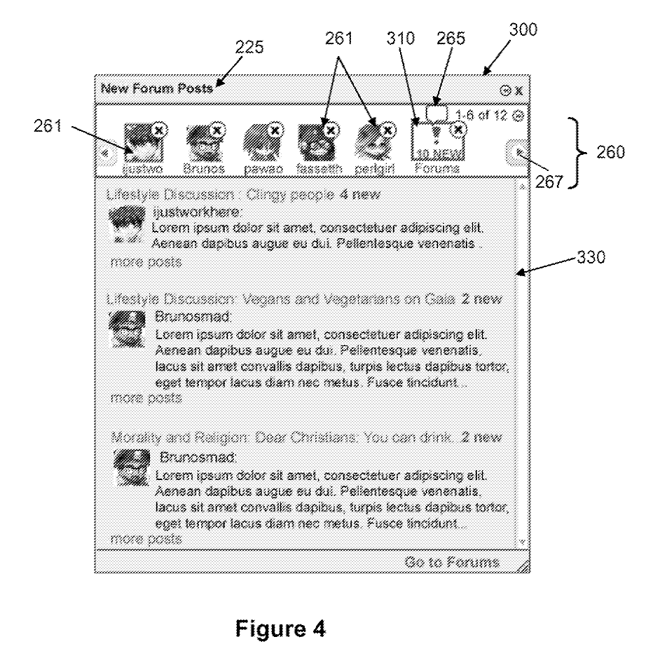

Referring to FIGS. 3 and 4, the integrated IM user interface 300 further includes an avatar-style icon 310 in the functional area 260. The icon 310 can be placed next to the avatars 261 that represent Ling's friends. The functional area 260 (i.e. carousal) can thus integrate different types of communication channels (e.g. IM and Forum) in a single integrated view, which is more easily visualized and managed by the IM user. The IM user “Ling” can click the icon 310 to view posts in one or more forum(s) within the same integrated IM user interface 300, as shown in FIG. 4. An IM user such as “Ling” can subscribed to a plurality of Forums such as “Lifestyle Discussion” and “Morality and Religion”. The subscription can be started by joining buddies' forums, as described above, or by signing up at forums' sign-up web pages. A user can also start up a new forum by specifying a topic and/or by incorporating an IM thread into the new forum. A forum posting area 330 in the Forum view of the integrated IM user interface 300 can display posted messages from a plurality of forums that the IM user “Ling” subscribes to in a single view. The integrated IM user interface 300 can also allow the IM user to receive messages from RSS feeds. The IM user can click at the avatars 261 to switch back to the IM views in the integrated IM user interface as shown FIGS. 2A-2C.

An advantage of the integrated IM user interface is that it allows an IM user to efficiently manage multiple modes of communications through a common user interface. The user can go to a Forum from the integrated IM user interface, or pull in contact information (i.e. buddies' names) from other sources such as a Forum or an email service.

Another advantage of the integrated IM user interface is that it allows an IM user to conduct both synchronous and asynchronous communications. The IM user can conduct synchronous communications using the IM functions as described in FIGS. 2A-4 and related discussions above. The IM user can also conduct asynchronous communications by viewing postings on Forums without having to responding or instantly responding to other users' posts.

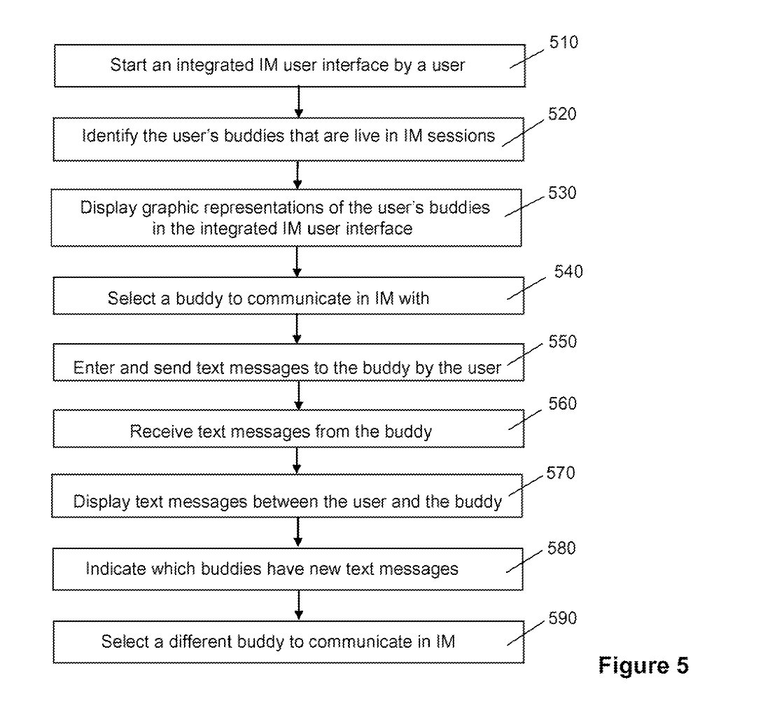

An exemplified process for instant messaging can include one or more of the following steps. Referring to FIG. 5, a user can activate an integrated user interface on a computer device in communication with an instant messaging system 100 over a computer network (step 510). The integrated IM user interface then determines the user's buddies that are in live IM communications using the IM service (step 520). One or more graphic representations such as avatars of the user's buddies are displayed (step 530). The user can select a buddy to have IM with by clicking on the graphic representation associated with the buddy (step 540). The user can enter and send text messages to the buddy using the integrated IM user interface (step 550). The integrated IM user interface can receive text messages from the buddy (step 570), and display text messages between the user and his buddy (step 570). The integrated IM user interface can also display which other of his buddies have new text messages (step 580). The user can select another buddy to communicate in instant messaging using the integrated IM user interface (step 590). The user can also use the integrated IM user interface to view postings in one or more forums that the user subscribed to.

Although specific embodiments of the present invention have been illustrated in the accompanying drawings and described in the foregoing detailed description, it will be understood that the invention is not limited to the particular embodiments described herein, but is capable of numerous rearrangements, modifications, and substitutions without departing from the scope of the invention. For example, the disclosed integrated IM user interface is compatible with different computer devices that can access the website, and different layouts and different forms of web user interfaces on computer devices. The computer devices compatible with the systems, methods and user interface for instant messaging can include various types of computers (desktop, laptop, tablet, etc.), portable devices (PDA, cell phones, IPEG music players, and portable gaming machines, etc.), and stationary gaming kiosks.

What is claimed is:

1. An integrated instant messages (IM) user interface for exchanging IM in a network-based community, comprising:
a text entry area configured to receive a text message from a first user;
a first graphic representation representing a second user, wherein the first graphic representation is configured to be activated by the first user to start an IM session between the first user and the second user;
a second graphic representation representing a third user associated with the first user, wherein the second graphic representation is configured to be activated by the first user to start an IM session between the first user and the third user; and
a chat window configured to display text messages between the first user and the second user or between the first user and the third user.

2. The integrated IM user interface of claim 1, wherein the first graphic representation is an avatar that is designed or selected by the second user.

3. The integrated IM user interface of claim 1, wherein the first graphic representation is positioned adjacent to the second graphic representation in a same functional area of the integrated IM user interface.

4. The integrated IM user interface of claim 3, further comprising a symbol in association with the second graphic representation, wherein the symbol is configured to indicate new or an unread instant message(s) sent by the third user.

5. The integrated IM user interface of claim 1, further comprising a plurality of graphic representations each representing a different user associated with the first user, wherein each of graphic representations is configured to be activated by the first user to start an IM session between the first user and the user represented by the graphic representation.

6. The integrated IM user interface of claim 5, wherein there are six or more graphic representations each representing a different user associated with the first user.

7. The integrated IM user interface of claim 1, further comprising an icon configured to indicate forum posting(s) from users associated with the first user, wherein the icon is configured to be activated by the first user to view forum posting(s) from the users associated with the first user.

8. The integrated IM user interface of claim 7, wherein the icon is positioned adjacent to the first graphic representation in a same functional area of the integrated IM user interface.

9. The integrated IM user interface of claim 7, further comprising a symbol in association of the icon, wherein the symbol is configured to indicate new or an unread forum posting(s) from users associated with the first user.

10. The integrated IM user interface of claim 1, further comprising a functional area configured to display an IM user name for the first user or for the second user.

11. The integrated IM user interface of claim 1, further comprising a functional area configured to display status information about the second user, wherein the status information comprises a subscription of the second user to on or more of a forum, an online community, or an online gaming service.

12. The integrated IM user interface of claim 1, further comprising a control button which, when activated, allows the first user to send the text message.

13. The integrated IM user interface of claim 1, further comprising a control button configured to facilitate the selection of a feature of the text message by activating the control, wherein the feature is selected from a group consisting of font size, font color, and font, style.

14. An integrated IM user interface for exchanging instant messages (IM) in a network-based community, comprising:
a text entry area configured to receive a text message from a first user;
a first graphic representation representing a second user, wherein the first graphic representation is configured to be activated by the first user to start an IM session between the first user and the second user;
a plurality of graphic representations each representing a different user associated with the first user, the first graphic representation and the plurality of graphic representations are positioned adjacent to each other, wherein each of graphic representations is configured to be activated by the first user to start an IM session between the first user and the user represented by the graphic representation;
a first symbol in association with one of the plurality of graphic representations, wherein the first symbol indicates one or more new or an unread instant message(s) sent by a different user represented by the one of the plurality of graphic representations;
a chat window configured to display text messages between the first user and the second user or between the first user and one of the different users represented by the plurality of graphic representations;
a control button which when actuated, allows the first user to send a text message to the second user or one of the different users;
an icon positioned adjacent to the first graphic representation or the plurality of graphic representations, wherein the icon is configured to indicate new or an unread forum posting(s) from users associated with the first user, and wherein the icon is configured to be activated by the first user to view forum posting(s) from the users associated with the first user.

15. The integrated IM user interface of claim 14, wherein there are six or more graphic representations each representing a different user associated with the first user.

16. A network-based instant messages (IM) system, comprising:
one or more servers configured to provide an integrated IM user interface on a first remote computer device, wherein the integrated IM user interface comprises:
a text entry area configured to receive a text message from a first user;
a first graphic representation representing a second user operating a second remote computer device, wherein the first graphic representation is configured to be activated by the first user to start an IM session between the first user and the second user;
a second graphic representation representing a third user operating a third remote computer device, wherein the second graphic representation is configured to be activated by the first user to start an IM session between the first user and the third user; and
a chat window configured to display text messages between the first user and the second user or between the first user and the third user,
wherein the one or more servers are configured to transmit the text messages between the first remote computer device and the second remote computer device, or between the first remote computer device and the third remote computer device; and
a computer storage device configured to store the text messages, the first graphic representation, and the second graphic representation.

17. The network-based IM system of claim 16, wherein the first graphic representation is an avatar that is designed or selected by the second user.

18. The network-based IM system of claim 16, wherein the first graphic representation is positioned adjacent to the second graphic representation in a same functional area of the integrated IM user interface.

19. The network-based IM system of claim 16, wherein the integrated IM user interface further comprises a symbol in association with the second graphic representation, wherein the symbol is configured to indicate new or unread instant message(s) sent by the third user.

20. The network-based IM system of claim 16, wherein the integrated IM user interface further comprises an icon configured to indicate forum posting(s) from users associated with the first user, wherein the icon is configured to be activated by the first user to view forum posting(s) from the users associated with the first user.

21. The network-based IM system of claim 20, wherein the icon is positioned adjacent to the first graphic representation in a same functional area of the integrated IM user interface.

22. The network-based IM system of claim 20, wherein he integrated IM user interface further comprises a symbol in association of the icon, wherein the symbol is configured to indicate new or an unread forum posting(s) from users associated with the first user.

23. The network-based IM system of claim 16, wherein the integrated IM user interface is configured to display a first IM user name associated with the first user and a second IM user name associated with the second user, wherein the computer storage device configured to store the first IM user name in association with the first user and the second IM user name in association with the second user.
